(19) United States
(12) Patent Application Publication
(10) Pub. No.: US 2004/0228405 A1
(43) Pub. Date: Nov. 18, 2004

(54) Moving picture coding method

(75) Inventors: Jae Shin Yu, Seoul (KR); Joo Min Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/842,560

(22) Filed: May 11, 2004

(30) Foreign Application Priority Data
May 12, 2003 (KR) 2003/29853

(51) Int. Cl. H04N 7/12

(52) U.S. Cl. 375/240.03; 375/240.16; 375/240.2; 375/240.12

(57) ABSTRACT

There is provided a moving picture coding method, which hides data in multimedia images. The moving picture coding method includes the steps of: extracting a motion vector of an inputted image through a motion estimation and a motion compensation, and performing a DCT (discrete cosine transform) to a difference image of the inputted image to set an initial quantization parameter; performing a data hiding to the set quantization parameter, and changing the quantization parameter to recognize whether or not the data hiding is performed; performing a quantization using the changed quantization parameter; and performing a data hiding by changing a level value of each block by block unit, to which a DCT is performed.

### BACKGROUND OF THE INVENTION

1. Field of the Invention

The present invention relates to a moving picture coding method, and more particularly, to a moving picture coding method which hides data in multimedia images.

2. Description of the Related Art

In recent years, there have been developed many technologies that can hide data in digital multimedia (image, video, audio, etc.) and, if necessary, extract the hidden data for a desired operation. Such technologies are largely classified into two categories. One requires an original data in which the data hiding is not performed, and the other does not require the original data.

In early stage, data that are hidden in the digital multimedia are mainly a copyright of author. However, since the digital multimedia can be duplicated identically to an original data, the copyright of author cannot be protected. In order to solve these problems, there have been developed technologies that cane hide specific data in the original data and, if necessary, extract the hidden data in order to identify the author of the corresponding digital multimedia. Also, the data hiding is used to protect secret communication or piracy of data. In this manner, various applications can be made using the data hiding technology in the digital multimedia.

However, as described above, the data hiding may require the original data or may include complex encryption algorithm. Accordingly, applied fields of the data hiding are greatly limited. Specifically, since the original data cannot be used in an applied field of real-time data communication, there is a demand for a fast data hiding algorithm that does not put a burden on the real-time communication without using the original data.

In multimedia moving picture communications that are widely used in recent years, the data hiding must be able to be performed using a fast and simple algorithm. In addition, after the data hiding is performed, an amount of data must not increase and a picture quality must not be changed.

Meanwhile, since an amount of data is very large in the multimedia moving picture communication, video compression technologies such as data compression are widely used.

### SUMMARY OF THE INVENTION

Accordingly, the present invention is directed to a moving picture coding method that substantially obviates one or more problems due to limitations and disadvantages of the related art.

An object of the present invention is to provide a moving picture coding method, which is capable of hiding desired data in multimedia moving picture that uses a video codec and, if necessary, extracting the hidden data. According to the present invention, an amount of encoding data does not increase and a picture quality is not changed. When the hidden data is extracted, an original data is unnecessary.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a moving picture coding method includes the steps of: extracting a motion vector of an inputted image through a motion estimation and a motion compensation, and performing a DCT (discrete cosine transform) to a difference image of the inputted image to set an initial quantization parameter; performing a data hiding to the set quantization parameter, and changing, the quantization parameter to recognize whether or not the data hiding is performed, performing a quantization using the changed quantization parameter; and performing a data hiding by changing a level value of each block by block unit to which a DCT is performed.

According to another embodiment of the present invention, a moving picture coding method includes the steps of: extracting a motion vector of an inputted image through a motion estimation and a motion compensation, and performing a DCT (discrete cosine transform) to a difference image of the inputted image to set an initial quantization parameter; performing a quantization using the set quantization parameter; and performing a data hiding to a level value of a block in which the DCT is performed, the level value being given by dividing DCT coefficient by the quantization parameter, and changing the level value to recognize whether or not the data hiding is performed.

According to a further another embodiment of the present invention, a moving picture coding method includes the steps of: extracting a motion vector of an inputted image through a motion estimation and a motion compensation, and performing a DCT (discrete cosine transform) to a difference image of the inputted image to set an initial quantization parameter; performing a first data hiding to the set quantization parameter, and changing the quantization parameter to recognize whether or not the first data hiding is performed; performing a quantization using the changed quantization parameter, and performing a second data hiding to a level value of a block in which the DCT is performed, the level value being given by dividing DCT coefficient by the quantization parameter, and changing the level value to recognize whether or not the data hiding is performed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of a related art coding process;

FIG. 2 is a view of a data hiding using a quantization parameter in a moving picture coding method according to the present invention;

FIG. 3 is a view of a data hiding using a level value in a moving picture coding method according to the present invention; and

FIG. 4 is a flowchart illustrating a moving picture coding method including data hiding according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

According to the present invention, data are hidden in multimedia moving picture and, if necessary, the hidden data are extracted, thus performing desired operations.

Data hiding is a technology that hides information in digital multimedia and, if necessary, extracts the hidden information. The data hiding can be largely classified into two categories. One requires an original image and the other does not require an original image when the hidden information is extracted. The data hiding that does not require the original image is be used in this invention.

In this invention, the data hiding is performed in the video compression. A related art moving picture coding method will now be described in brief with reference to FIG. 1. FIG. 1 is a schematic view of a related art moving picture coding process.

Referring to FIG. 1, motion estimation and motion compensation are performed to an input image to extract motion vector. Then, discrete cosine transform (DCT) and quantization are performed to a difference image. Variable length coding (VLC) is performed to the quantized data in order for more efficient data compression.

An original image is restored by adding the previous image and the inverse quantized and inverse DCTed image. A difference image of next image is obtained using the restored image. In this manner, video data compression is achieved.

In the data hiding, there must not be a difference in a picture quality from an original data. Also, even after the data hiding is performed, an amount of compressing data must not increase. In the video compression, the amount of compressing data means an amount of transmitting data. Therefore, if the compressing data increases, a transmitting cost increases.

When the input image is compressed, the data hiding can be performed using parameters, which are used in the data compression, or by changing values that are dependent on the input image. In order to achieve the data hiding in the video compression, the data hiding must not affect the picture quality or amount of compressing data, even if original parameter or data are changed through the data hiding such values are quantization parameter (QP) and “level” value. The level value is given by dividing DCT coefficient by quantization parameter.

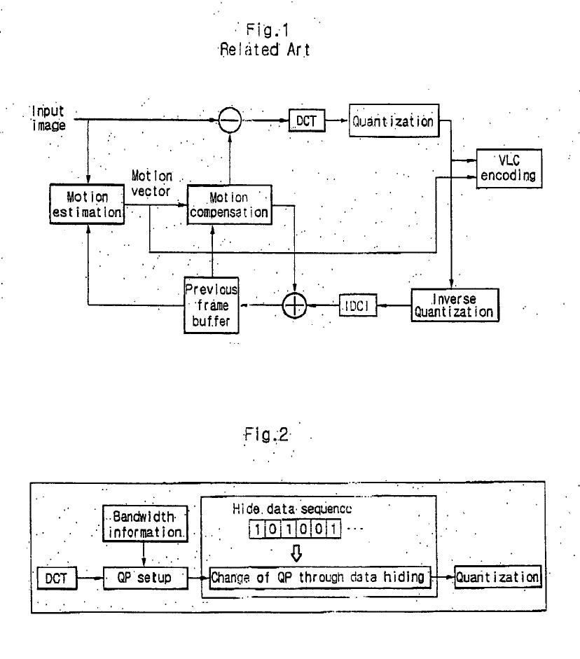

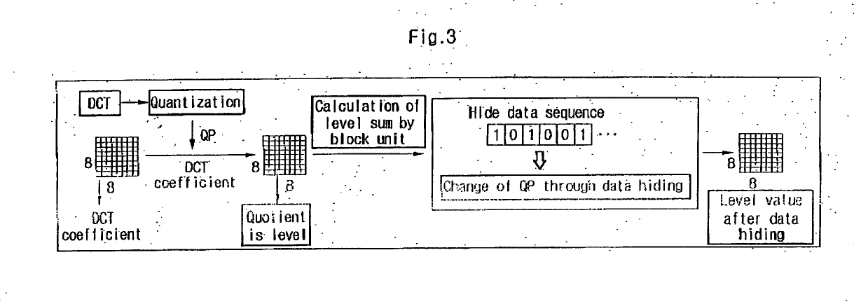

FIG. 2 illustrates the data hiding using the quantization parameter in the moving picture coding method according to the present invention.

As is well known, it is the quantization parameter that adjusts an amount of encoding data. The quantization parameter is a parameter that is used to divide the input image or its difference value by DCT coefficient. If the quantization parameter increases, a value divided by the DCT coefficient becomes large, so that an amount of the encoding data decreases. On the contrary, if the quantization parameter decreases, a value divided by the DCT coefficient becomes small, so that an amount of the encoding data increases.

When the video moving pictures are received and transmitted through a network, data are compressed to match with bandwidth of the network. If the bandwidth of the network is wide, an amount of communication data becomes large, so that an encoding amount increases and thus the picture quality is improved. On the contrary, if the bandwidth of the network is narrow, an amount of communication data becomes small, so that an encoding amount decreases and thus the picture quality is degraded. Considering these network conditions, the amount of the encoding data is adjusted using the quantization parameter. At this point, the data hiding is performed.

Referring to FIG. 2, the discrete cosine transform (DCT) is performed to the input image or its difference image and then an appropriate quantization parameter is set, considering the bandwidth of the network. The quantization parameter is used to decode the compressed image after entering a macroblock header. At this point, the data hiding is performed before the quantization is carried out using the quantization parameter. Here, the data hiding can be performed as follows:

QP_new %2==Hide bit [k]

QP_new: No change

QP_new %2!=Hide bit [k]

QP_new=QP_new+1;

Hide bit [k]: bit stream of data to be hidden

If the data hiding is performed in the above manner, the hidden data can be extracted based on the quantization parameter while the decoder decodes the compressed data. If the quantization parameter in the decoder is an even number, the hidden data becomes “0”, and if the quantization parameter is an odd number, the hidden data becomes “1”.

At this point, the quantization parameter is slightly changed at the encoder in order for the data hiding. In other words, when the data to be hidden and the quantization parameter are divided by 2, if the remainders are equal to each other, the value of the quantization parameter increases, by 1, thereby making the remainders equal to each other. In this case, the divisor of the DCT coefficient increases so that an amount of the encoding data is reduced. However, human's eyes cannot almost recognize the degradation of the picture quality.

FIG. 3 is a view of a data hiding process using the level value in the moving picture coding method according to the present invention. In other words, in FIG. 3, data hiding is performed to the “level” value, which is given by quantizing the DCT coefficient of the input image or difference image.

According to the moving picture coding method of the present invention, the DCT is performed to the input image or difference image for the purpose of compression. Then, considering the transmission bandwidth the quantization parameter is assigned to adjust an amount of encoding bit. The DCT coefficient is divided by the quantization parameter.

In FIG. 3, the DCT is performed by 8×8 block unit. The quantization parameter is applied to the DCTed block and the coefficient is divided. When the coefficient is divided by the quantization parameter, the resultant quotient is referred to as “levels”. The data hiding is performed using the levels produced at each block. Here, the data hiding can be expressed as follows:

LevelSum %2==Hide Bit [k]

Level: No change

LevelSum %2!=Hide Bit [k]

A value of a level having the lowest significance decreases by 1

LevelSum: Sum of all levels of blocks.

The reason why the data hiding is performed not in the respective levels but in the sum of levels by block unit is that the picture quality is affected when the data hiding is performed to the respective levels. As the quantization parameter becomes larger, one level's range of DCT coefficient becomes wider, because the level is the quotient of the value given by dividing the DCT coefficient by the quantization parameter.

For example, in case the level values are equal to 1, if the quantization parameter is 10, the available DCT coefficient ranges from 10 to 19, and if the quantization parameter is 30, the available DCT coefficient ranges from 30 to 59. Thus, when the sum of the levels is calculated by 8×8 block unit and divided by 2, if the resultant remainder and the data bit to be hidden are equal to each other, the level is not changed, and if not, a value of a level having the lowest significance decreases by 1.

Here, the level having the lowest significance represents a region having the least sensitivity to human's eyes. Meanwhile, human's eyes are least sensitive to high frequency range. Therefore, if the data bit to be hidden and the remainder made by dividing the “level sum” by 2 are not equal to each other, the value of the level having the highest frequency decreases by 1.

If the “level sum” is “16” and the bit to be embedded is “1”, the value of the “level” corresponding to the highest frequency block among the blocks decreases by “1”. Thus, the “level sum” becomes “15”, so that the bit to be hidden and the remainder given by dividing the “level sum” by 2 are made to be equal to each other.

However, a problem occurs when the “level sum” is “1”. If the “level sum” is “1” and the bit to be hidden is “1”, a sum of the total blocks becomes “0” when the level value of the region having the lowest sensitivity decreases by 1. However, since the level of the block whose original sum is “0” cannot be decreased any more, the data hiding is not performed. In this case, the block whose “level sum” is changed from “1” to “0” through the data hiding cannot be distinguished from the block whose original “level sum” is “0” and having no data hiding.

The present invention makes use of a following method in order to prevent these errors.

In case the “level sum” is “1” and the data to be hidden is “1”, data is embedded into the corresponding block. In this case, the “level sum” is not changed. In case the “level sum”is “1” and the data to be hidden is “0”, the “level sum” of the corresponding block is changed to “0” and the data hiding is not performed. When the “level sum” is “0”, the decoder considers that there is no data hiding in the corresponding block.

In this manner, if the data to be hidden and the remainder made by dividing a sum of the blocks by 2 are equal to each other, the levels of all the blocks, except for the block having the “level sum” of “1”, are not changed, and if not, the data can be hidden by decreasing the level of the region having the lowest sensitivity by 1.

In case of the block having the “level sum” is “1”, if the data to be hidden is “1”, the data is hidden. On the contrary, if the data to be hidden is “0”, the data is not hidden, but only the level value of the block is changed to “0”. When the “level sum” is “0”, the data hiding is not performed.

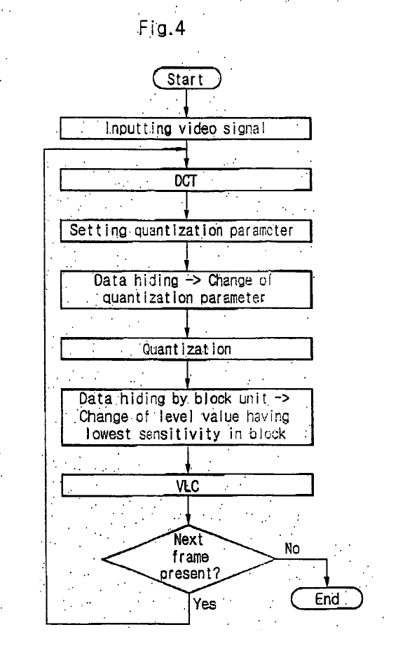

FIG. 4 is a flowchart illustrating a moving picture coding method including data hiding according to the present invention.

If the video image is inputted, a general video codec performs DCT, quantization, and VLC to compress the video image. When the quantization is performed to the DCTed data, the value given by dividing the quantization parameter by 2 and the data bit to be hidden are not equal to each other in the data bit stream to be hidden, the quantization parameter increases by 1.

Then, the quantization is performed using the quantization parameter in which the data hiding is performed. The DCT value after the quantization is referred to as “level”. The data hiding is performed using a level sum by block unit. A remainder given by dividing the level sum of the block by 2 and the data bit to be hidden are not equal to each other, a level value of a region having the lowest sensitivity in the block decreases by 1. If the level sum is “1”, the data hiding is performed selectively, and if the level sum is “0”, the data hiding is not performed.

According to the moving picture coding method of the present invention, the data hiding can be achieved in the multimedia data compression using the video codec. Also, while compressing the general moving pictures, desired information can be stored in the stream which is being compressed. Therefore, various applications can be made by extracting the stored information at a desired time point.

For example, it is possible to hide an author of a certain moving picture or to allow only a specific user to view the moving picture. Also, it is possible to cope with the error occurring in the communication environment using the data hiding or to conceal the error more effectively. Since the data hiding can select the data to be hidden according to the user's intended object, its application is not limited to them.

According to the present invention, the desired data can be hidden in the multimedia moving picture and extracted if necessary. An amount of the encoding data does not increase and the picture quality is not changed. Also, when the hidden data is extracted, the original data is unnecessary.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A moving picture coding method, comprising the steps of:
extracting a motion vector of an inputted image through a motion estimation and a motion compensation, and performing a discrete cosine transform (DCT) to a difference image of the inputted image to set an initial quantization parameter;
performing a data hiding to the set quantization parameter, and changing the quantization parameter to recognize whether or not the data hiding is performed;
performing a quantization using the changed quantization parameter; and
performing a data hiding by changing a level value of each block by block unit, to which a DCT is performed.

2. The moving picture coding method according to claim 1, wherein the quantization parameter is changed by comparing the set initial quantization parameter with data bit to be hidden.

3. The moving picture coding method according to claim 1, wherein the quantization parameter is changed to make a remainder given by dividing the initial quantization parameter by 2 and data bit to be hidden equal to each other.

4. The moving picture coding method according to claim 1, wherein the quantization parameter increases by 1 if a remainder given by dividing the initial quantization parameter by 2 and data bit to be hidden are not equal to each other.

5. A moving picture coding method, comprising the steps of:
extracting a motion vector of an inputted image through a motion estimation and a motion compensation, and performing a discrete cosine transform (DCT) to a difference image of the inputted image to set an initial quantization parameter;
performing a quantization using the set quantization parameter; and
performing a data hiding to a level value of a block in which the DCT is performed, the level value being given by dividing DCT coefficient by the quantization parameter, and changing the level value to recognize whether or not the data hiding is performed.

6. The moving picture coding method according to claim 5, wherein the data hiding is performed using a level sum by block unit.

7. The moving picture coding method according to claim 5, wherein the level value is changed to make a remainder given by dividing a level sum by 2 and data bit to be hidden equal to each other.

8. The moving picture coding method according to claim 5, wherein a level having a lowest sensitivity to human's eyes decreases by 1 if a remainder given by dividing a level sum by 2 and data bit to be hidden are not equal to each other.

9. The moving picture coding method according to claim 8, wherein the level having the lowest sensitivity to human's eyes is a level having a highest frequency.

10. The moving picture coding method according to claim 5, wherein if a level sum is 1 and data to be hidden is 0, the level sum is changed to 0 and the data hiding is not performed.

11. The moving picture coding method according to 5, wherein if a level sum is 0, the data hiding is not performed.

12. A moving picture coding method, comprising the steps of:
extracting a motion vector of an inputted image through a motion estimation and a motion compensation and performing a discrete cosine transform (DCT) to a difference image of the inputted image to set an initial quantization parameter;
performing a first data hiding to the set quantization parameter, and changing the quantization parameter to recognize whether or not the first data hiding is performed;
performing a quantization using the changed quantization parameter; and
performing a second data hiding to a level value of a block in which the DCT is performed, the level value being given by dividing DCT coefficient by the quantization parameter, and changing the level value to recognize whether or not the data hiding is performed.

13. The moving picture coding method according to claim 12, wherein the quantization parameter is changed to make a remainder given by dividing the initial quantization parameter by 2 and data bit to be hidden equal to each other.

14. The moving picture coding method according to claim 12, wherein the level value is changed to make a remainder given by dividing a level sum by 2 and data bit to be hidden equal to each other.
